(19) United States
(12) Patent Application Publication
(10) Pub. No.: US 2003/0121377 A1
(43) Pub. Date: Jul. 3, 2003

(54) Wood lathe

(76) Inventor: Juei-Seng Liao, Taichung City (TW)

Correspondence Address: WEBB ZIESENHEIM LOGSDON ORKIN & HANSON P.C., 700 Koppers Building, 436 Seventh Avenue, Pittsburgh, PA, 15219-1818, US

(21) Appl. No.: 10/098,662

(22) Filed: Mar. 15, 2002

(30) Foreign Application Priority Data
Dec. 31, 2001 (TW) 090224284

(51) Int. Cl. B23B 19/00; B27C 7/00

(52) U.S. Cl. 82/142; 142/1

(57) ABSTRACT

A wood lathe includes a bed, a headstock mounted on the bed and having a headstock housing, a motor mounted in the headstock housing and having a driving shaft with opposite first and second output ends, a spindle journalled to the headstock housing, a first transmission interconnecting the first output end and the spindle, a cooling fan disposed in the headstock housing for cooling the motor and including a driven shaft that is journalled to the headstock housing, and a second transmission interconnecting the second output end and the driven shaft so as to permit rotation of the driven shaft when the motor is actuated, which, in turn, cools the motor.

### CROSS-REFERENCE TO RELATED APPLICATION

This application claims priority of Taiwan Application No. 90224284, filed on Dec. 12, 2001.

### BACKGROUND OF THE INVENTION

This invention relates to a wood lathe, more particularly to a wood lathe with a cooling fan for cooling a motor on the wood lathe.

### SUMMARY OF THE INVENTION

The object of the present invention is to provide a wood lathe that includes a motor with two output ends for driving a spindle for machining a workpiece and a cooling fan for cooling the motor.

According to the present invention, a wood lathe comprises: a bed; a headstock mounted on the bed and having a headstock housing; a motor mounted securely in the headstock housing and having a driving shaft with opposite first and second output ends; a spindle rotatably journalled to the headstock housing for holding a workpiece; a first transmission interconnecting the first output end and the spindle so as to permit rotation of the spindle when the motor is actuated; a cooling fan disposed in the headstock housing adjacent to the motor for cooling the motor, the cooling fan including a driven shaft that is rotatably journalled to the headstock housing and that is parallel to the second output end; and a second transmission interconnecting the second output end and the driven shaft so as to permit rotation of the driven shaft when the motor is actuated, which, in turn, cools the motor.

### BRIEF DESCRIPTION OF THE DRAWINGS

In drawings which illustrate an embodiment of the invention,

FIG. 1 is a fragmentary perspective view of a wood lathe embodying this invention;

FIG. 2 is a fragmentary schematic front view of the wood lathe of FIG. 1;

FIG. 3 a fragmentary perspective rear view of the wood lathe of FIG. 1;

FIG. 4 is an exploded perspective view of a headstock housing, a motor, and a cooling fan of the wood lathe of FIG. 1;

FIG. 5 is a fragmentary partly sectional view to illustrate how the motor is secured to the headstock housing of the wood lathe of FIG. 1; and

FIG. 6 is a fragmentary partly sectional view to illustrate how the cooling fan is driven by the motor of the wood lathe of FIG. 1.

### DETAILED DESCRIPTION OF THE PREFERRED EMBODIMENT

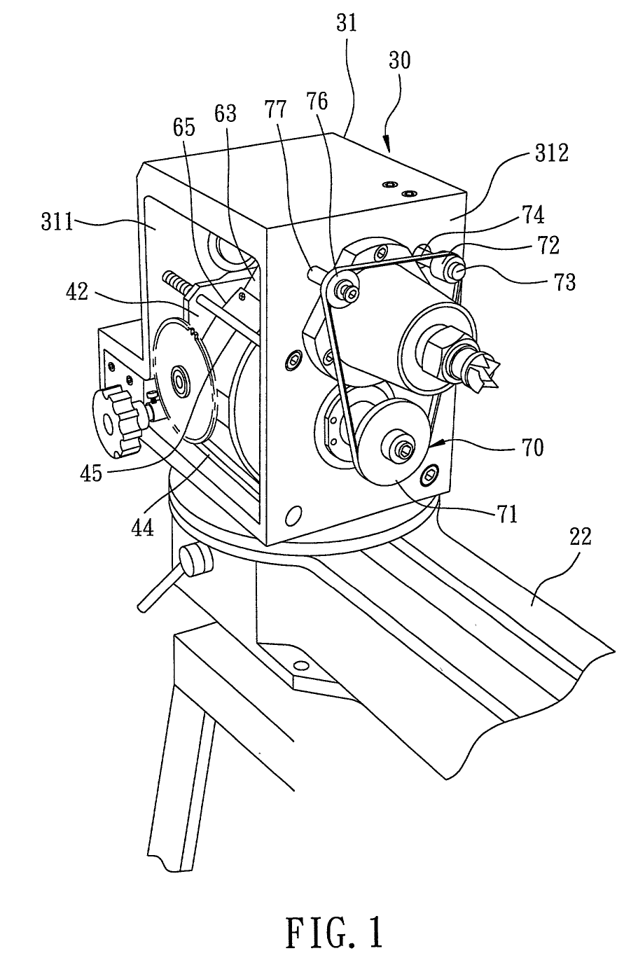

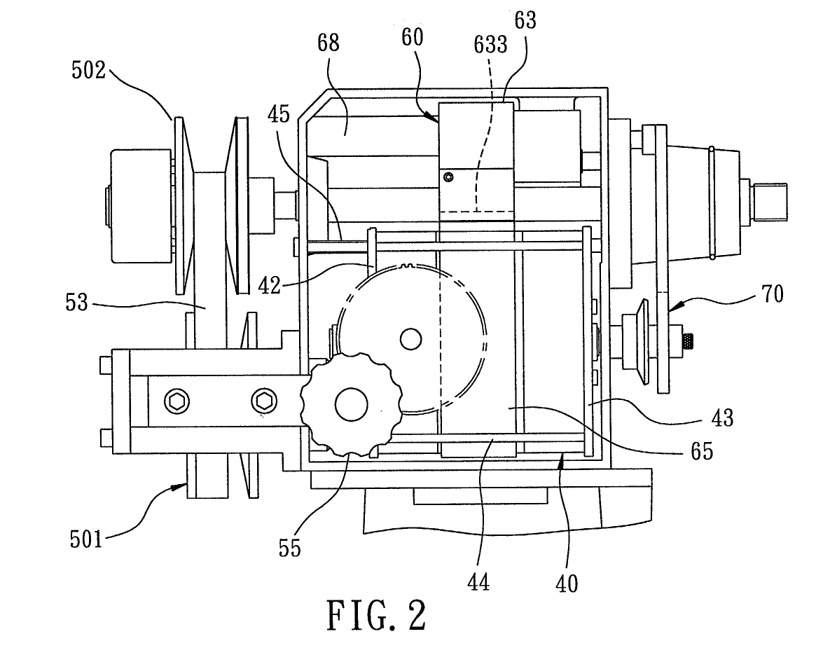

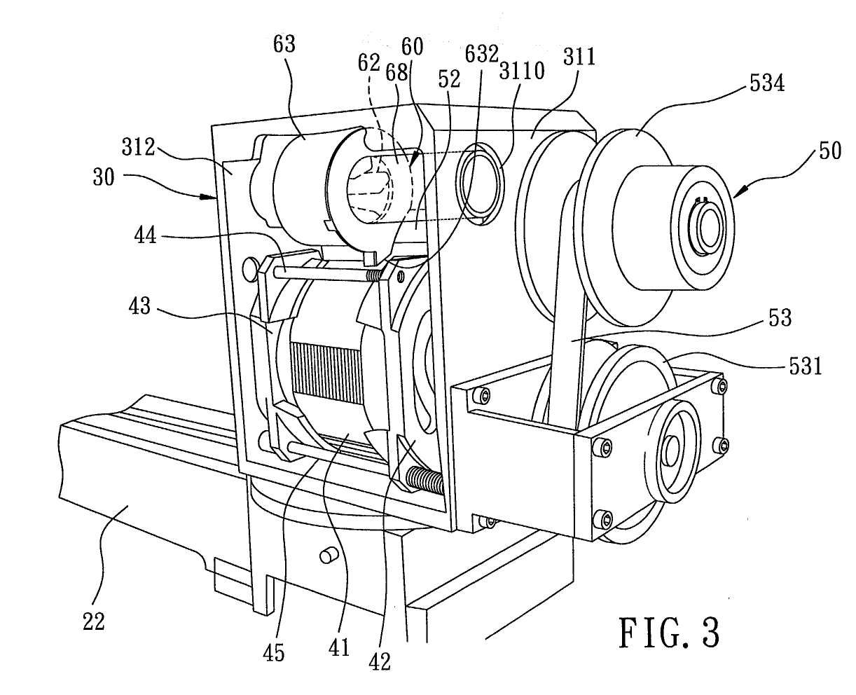

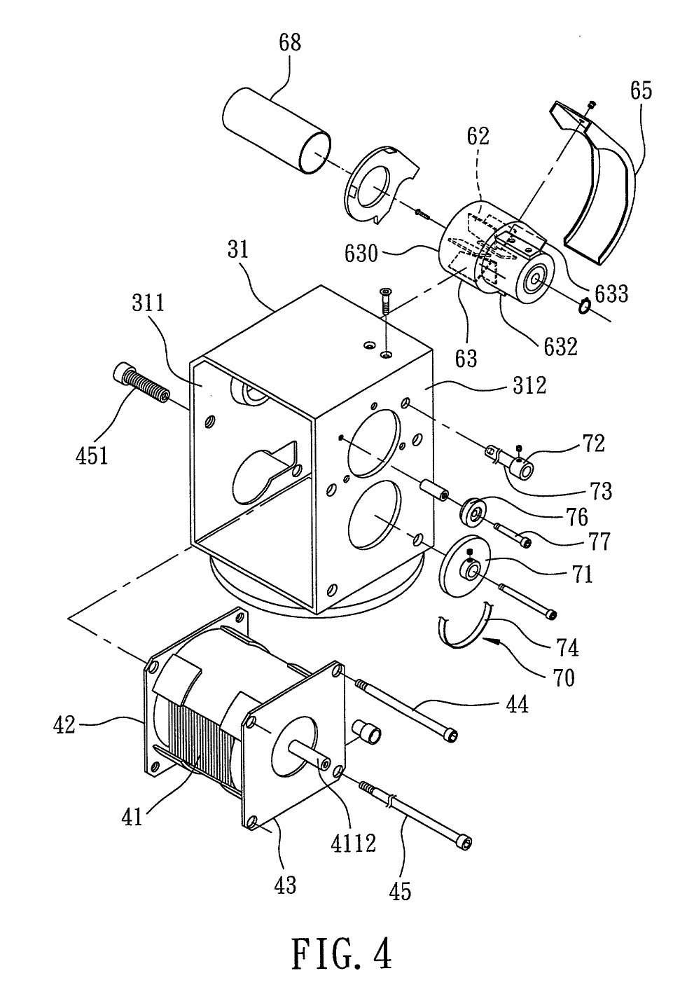

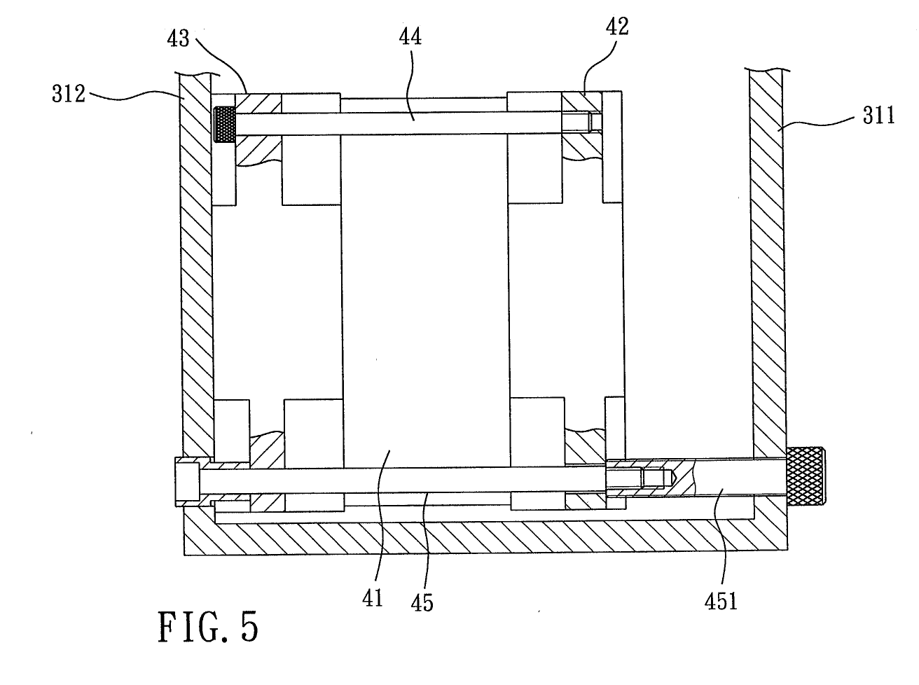

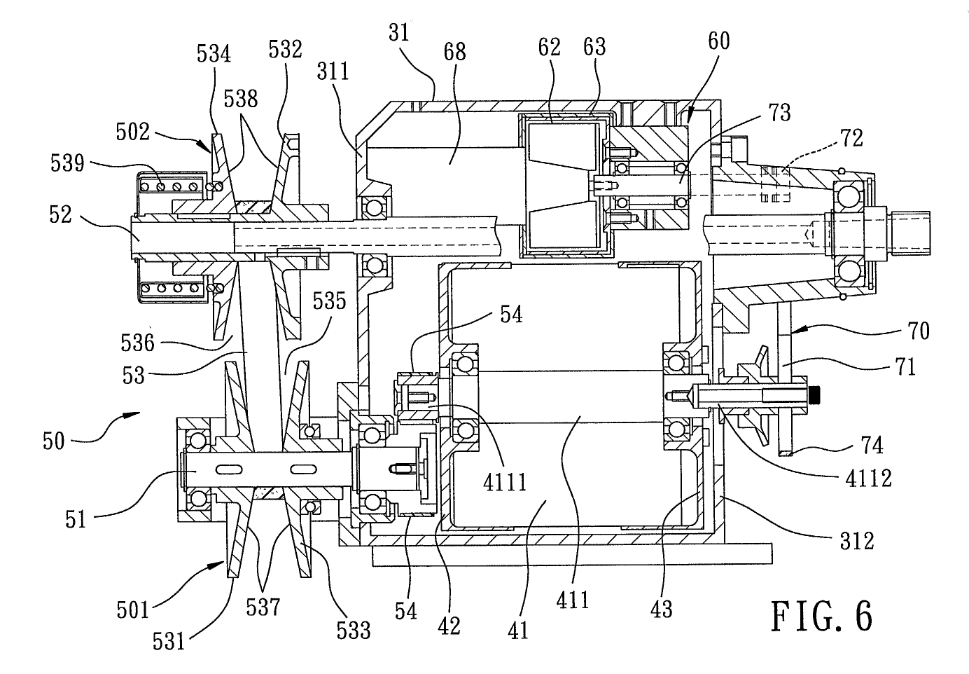

FIGS. 1 to 6 illustrate a preferred embodiment of a wood lathe of this invention for machining a wooden workpiece (not shown).

The wood lathe includes: a bed 22 (only a portion of the bed 22 is shown); a headstock 30 mounted on the bed 20 and having a headstock housing 31 that has left and right side walls 311, 312; a motor 41 mounted securely in the headstock housing 31 and having a driving shaft 411 with opposite first and second output ends 4111, 4112 projecting through the left and right side walls 311, 312, respectively; a spindle 52 rotatably journalled to and projecting through the left and right side walls 311, 312 of the headstock housing 31 for holding the workpiece, the spindle extending in a direction parallel to the driving shaft 411; a first transmission interconnecting the first output end 4111 of the driving shaft 411 and the spindle 52 so as to permit rotation of the spindle 52 when the motor 41 is actuated; a cooling fan 60 disposed in the headstock housing 31 adjacent to the motor 41 for cooling the motor 41, the cooling fan 60 including a driven shaft 73 that is rotatably journalled to and that projects through the right side wall 312 of the headstock housing 31 and that extends in a direction parallel to the driving shaft 411; and a second transmission 70 interconnecting the second output end 4112 of the driving shaft 411 and the driven shaft 73 so as to permit rotation of the driven shaft 73 when the motor 41 is actuated, which, in turn, cools the motor 41. The wood lathe further includes a tail-stock and a tool rest which are not shown in the aforesaid drawings for the sake of brevity.

The first transmission includes a connecting shaft 51, a gear unit 54 interconnecting the connecting shaft 51 and the first output end 4111 of the driving shaft 411, and a pulley-and-belt assembly 50 that interconnects the connecting shaft 51 and the spindle 52. The pulley-and-belt assembly 50 includes a first pulley unit 501 mounted on the connecting shaft 51, a second pulley unit 502 mounted on the spindle 52, and a non-elastic belt 53 interconnecting the first and second pulley units 501, 502. The first pulley unit 501 has a first fixed part 531 and a first movable part 533 that cooperates with the first fixed part 531 to define therebetween a first belt receiving space 535 and to form a radially and outwardly diverging first belt-engaging surface 537 that confines the first belt receiving space 535. The second pulley unit 502 has a second fixed part 532 and a second movable part 534 which cooperatively define therebetween a second belt receiving space 536 and which form a radially and outwardly diverging second belt-engaging surface 538 that confines the second belt receiving space 536. The second pulley unit 502 further has an urging member 539 that urges the second movable part 534 toward the second fixed part 532. The non-elastic belt 53 is frictionally slidable along the first and second belt-engaging surfaces 537, 538 of the first and second pulley units 501, 502 in such a manner that variation of position of the non-elastic belt 53 between the first and second pulley units 501, 502 results in change in the rotational speed of the spindle 52 with the driving shaft 411 rotating at a constant speed.

The second transmission 70 is a pulley-and-belt assembly that includes a motor-side pulley 71 mounted on the second output end 4112, a fan-side wheel 72 mounted on the driven shaft 73, a mounting rod 77 projecting from the headstock housing 31, an idle wheel 76 mounted rotatably on the mounting rod 77 and disposed at a position in such a manner that the idle wheel 76, the fan-side wheel 72, and the motor-side pulley 71 form a triangular relationship relative to each other, and a belt 74 interconnecting the motor-side pulley 71, the fan-side wheel 72, and the idle wheel 76.

The cooling fan 60 includes an annular fan housing 63 and a plurality of blades 62 that are disposed in the fan housing 63 and that are connected to the driven shaft 73 for generating air flow. The fan housing 63 has an open end that defines an air inlet 630 and that is in fluid communication with an exterior of the headstock housing 31 via a conduit 68 that extends from the air inlet 630 through an opening 3110 in the left side wall 311 so that fresh air can be introduced into the fan housing 63 upon actuation of the cooling fan 60. The fan housing 63, which is disposed above the motor 41, is formed with a first spout 632 that projects downwardly from a bottom thereof toward a top of the motor 41 for cooling the motor 41, and a second spout 633 that projects from one side thereof. An arcuate guide plate 65 is secured to and projects from the second spout 633 toward a side of the motor 41 for guiding air flow from the second spout 633 to the side of the motor 41 for enhancing the cooling effect.

A pair of square motor-mounting plates 42, 43 are secured to two opposite sides of the motor 41. A pair of diagonally disposed first screw rods 44 extend through the left and right side walls 311, 312 and two diagonal corners of each of the motor-mounting plates 42, 43. A pair of diagonally disposed second screw rods 45 extend through the right side wall 312 and the other two diagonal corners of each of the motor-mounting plates 42, 43 to threadedly and respectively engage two screw bolts 451 which are secured to the left side wall 311 so as to detachably secure the motor 41 to the headstock housing 31. The motor 41 can be detached by simply disengaging the second screw rods 45 from the screw bolts 451.

With the inclusion of the cooling fan 60 in the wood lathe of this invention, the motor 41 can be cooled. Moreover, since actuation of the cooling fan 60 is carried out by the motor 41 which is used for rotating the workpiece held by the spindle 52, there is no need to use extra driving means to actuate the cooling fan 60.

With the invention thus explained, it is apparent that various modifications and variations can be made without departing from the spirit of the present invention. It is therefore intended that the invention be limited only as recited in the appended claims.

I claim:

1. A wood lathe comprising:
a bed;
a headstock mounted on said bed and having a headstock housing;
a motor mounted securely in said headstock housing and having a driving shaft with opposite first and second output ends;
a spindle rotatably journalled to said headstock housing for holding a workpiece;
a first transmission interconnecting said first output end and said spindle so as to permit rotation of said spindle when said motor is actuated;
a cooling fan disposed in said headstock housing adjacent to said motor for cooling said motor, said cooling fan including a driven shaft that is rotatably journalled to said headstock housing and that is parallel to said second output end; and
a second transmission interconnecting said second output end and said driven shaft so as to permit rotation of said driven shaft when said motor is actuated, which, in turn, cools said motor.

2. The wood lathe of claim 1, wherein said second transmission is a pulley-and-belt assembly.

3. The wood lathe of claim 2, wherein said cooling fan includes an annular fan housing and a plurality of blades disposed in said fan housing and connected to said driven shaft, said fan housing being formed with an air inlet that is in fluid communication with an exterior of said headstock housing, and a first spout that projects toward said motor.

4. The wood lathe of claim 3, wherein said fan housing is further formed with a second spout that projects from one side thereof, said cooling fan further including an arcuate guide plate that is secured to and that projects from said second spout toward a side of said motor for guiding air flow from said second spout to said motor.
